(19) United States
(12) Patent Application Publication
(10) Pub. No.: US 2012/0124497 A1
(43) Pub. Date: May 17, 2012

(54) METHOD AND APPARATUS FOR DATA VIRTUALIZATION AND DISPLAY

(75) Inventors: Aruna Kasoju, Singapore (SG); Raghuveer Thandur, Singapore (SG); Thet Naing, Singapore (SG)

(73) Assignee: YOKOGAWA ELECTRIC CORPORATION, Tokyo (JP)

(21) Appl. No.: 12/945,399

(22) Filed: Nov. 12, 2010

(51) Int. Cl. G06F 3/048

(52) U.S. Cl. 715/764

(57) ABSTRACT

A method of data virtualization and display, the method comprising providing a first data set; providing a first view container for displaying data items therein and associating the first view container with the first data set; loading the first data set with selected data items obtained from a first master data collection; and automatically displaying the selected data items in the first view container. An apparatus for data virtualization and display, the apparatus comprising a first master data collection comprising a number of data items; a first data set configured to be loaded with selected data items from the first master data collection; and a first view container configured to display data items therein, the first view container being associated with the first data set such that the selected data items loaded in the first data set are automatically displayed by the first view container.

### TECHNICAL FIELD

The present invention relates to a method and apparatus for data virtualization and display.

### BACKGROUND

Virtualization allows data to be displayed to a user very quickly, in a matter of seconds, even though the amount of data may be very large. However, not all user interface controls support virtualization, and in other instances where virtualization is supported, there may also be situations where it cannot be used due to conflicting application demands.

### SUMMARY

A method and apparatus for custom data virtualization and display is provided to improve performance in application products that deal with large amounts of data, and particularly where user viewable data items are much fewer than the total number of data items in the data collection.

According to a first exemplary aspect, there is provided a method of data virtualization and display, the method comprising providing a first data set; providing a first view container for displaying data items therein and associating the first view container with the first data set; loading the first data set with selected data items obtained from a first master data collection; and automatically displaying the selected data items in the first view container.

The method may further comprise updating corresponding data items in the first master data collection when specific data items displayed in the first view container are operated upon.

The method may further comprise refreshing data items in the first data set that correspond with the updated corresponding data items in the first master data collection and automatically displaying the refreshed data items in the first view container.

The method may further comprise providing a second view container for displaying data items therein.

The second view container may be associated with a second data set. The method may further comprise loading the second data set with further selected data items obtained from the first master data collection; and automatically displaying the further selected data items in the second view container. Alternatively, the method may further comprise loading the second data set with predetermined data items obtained from a second master data collection; and automatically displaying the predetermined data items in the second view container. The method may further comprise displaying the second view container within the first view container.

Alternatively, the second view container may be associated with the first data set, and the method may further comprise loading the first data set with another portion of the selected data items obtained from the first master data collection; and automatically displaying the another portion of the selected data items in the second view container.

In a second exemplary aspect, there is provided an apparatus for data virtualization and display, the apparatus comprising a first master data collection comprising a number of data items; a first data set configured to be loaded with selected data items from the first master data collection; and a first view container configured to display data items therein, the first view container being associated with the first data set such that the selected data items loaded in the first data set are automatically displayed by the first view container.

The first master data collection and the first view container may be configured to update corresponding data items in the first master data collection when specific data items displayed in the first view container are operated upon.

The first master data collection and the first data set may be configured to refresh data items in the first data set that correspond with the updated corresponding data items in the first master data collection such that the refreshed data items are automatically displayed in the first view container.

The apparatus may further comprise a second view container configured to display data items therein.

The second view container may be associated with a second data set. The second data set may be configured to be loaded with further selected data items from the first master data collection, such that the further selected data items loaded in the second data set are automatically displayed by the second view container. Alternatively, the second data set may be configured to be loaded with predetermined data items from a second master data collection, such that the predetermined data items loaded in the second data set are automatically displayed by the second view container. The second view container may be configured to be displayed within the first view container.

Alternatively, the second view container may be associated with the first data set, such that another portion of the selected data items loaded in the first data set are automatically displayed by the second view container.

### BRIEF DESCRIPTION OF THE DRAWINGS

Embodiments will now be described by way of non-limitative example, the description being with reference to the accompanying illustrative drawings, in which:

FIG. 1 is an architecture diagram of an exemplary apparatus for data virtualization and display;

FIG. 2 is a flowchart of an exemplary use of the apparatus of FIG. 1;

FIG. 3 is an architecture diagram of the exemplary apparatus of FIG. 1 displaying data in a split view;

FIG. 4 is an architecture diagram of the exemplary apparatus of FIG. 1 displaying data in a hierarchy of views;

FIG. 5 is an architecture diagram of the exemplary apparatus of FIG. 1 displaying data in multiple views;

FIG. 6 is an architecture diagram of an exemplary apparatus for data virtualization and display in a combination of split, hierarchy of and multiple views; and

FIG. 7 is a flowchart of an exemplary method of data virtualization and display.

### DETAILED DESCRIPTION OF THE PREFERRED EMBODIMENTS

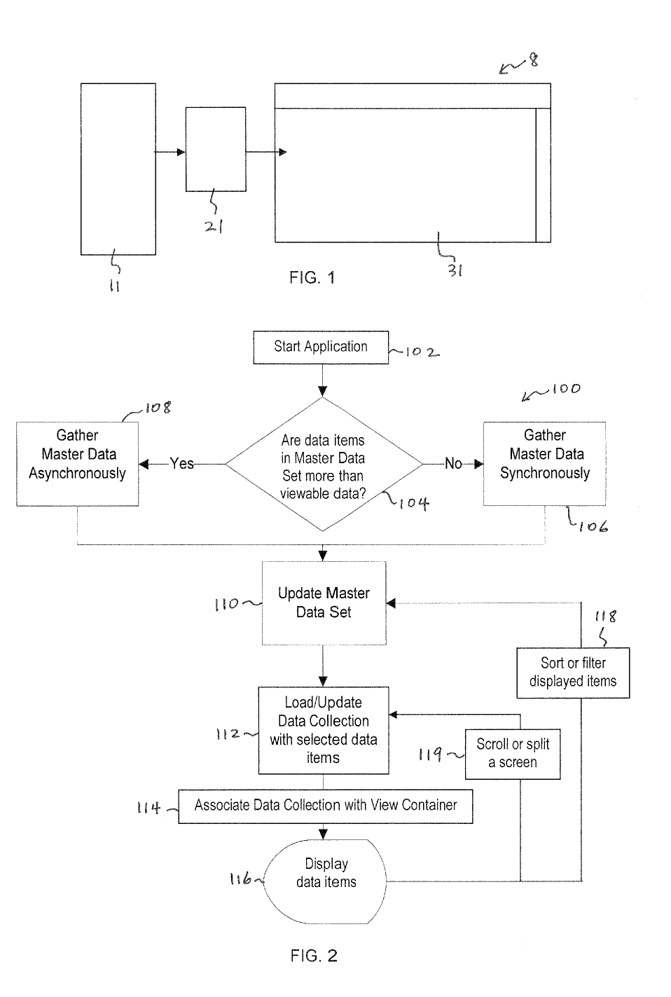

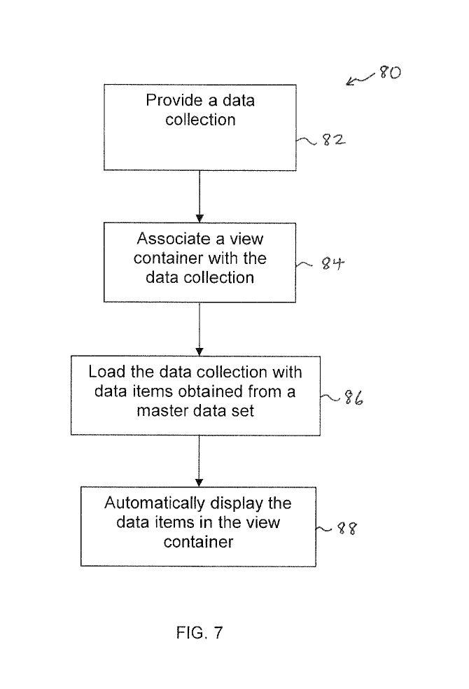

With reference to FIGS. 1 to 7, exemplary embodiments of a method 80 and apparatus 8 for data virtualization and display will now be described. Throughout this specification, the word “a” is not limited to mean “only one” and may mean “one or more”.

As depicted in FIG. 1, the apparatus 8 comprises a master data collection 11 comprising a number of data items. A data set 21 is provided (82), the data set 21 being configured to be loaded with selected data items from the master data collection 11. The apparatus 8 also comprises a view container 31 configured to display data items. The data set 21 is further configured to be associated with the view container 31 in order to bind the data set 21 to the view container 31. By associating or binding the data set 21 to the view container 31 (84), the selected data items that have been loaded in the data set 21 can be automatically displayed by the view container 31.

In use, as depicted in the flowchart 100 of FIG. 2, an application of the method 80 begins (102) by determining if the number of data items to be included in the master data collection 11 is greater than the number of data items that can be displayed by the view container 31 (104). If the answer is ‘No’, all the data items for the master data collection 11 are synchronously gathered (106). If the answer is ‘Yes’, data items for the master data collection 11 are asynchronously gathered (108), in accordance with a predetermined priority. The master data collection 11 is updated (110) as data items for inclusion in the master data collection 11 are gathered. For example, data items for the master data collection 11 may be data arising from operation of an industrial plant.

When a sufficient number of data items have been gathered in the master data collection 11, an event is triggered so that selected data items from the master data collection 11 are loaded into the data set 21 (112, 86).

The data set 21 is associated with the view container 31 (114, 84) so that the selected data items loaded in the data set 21 are automatically displayed by the view container 31 (116). Association of the data set 21 with the view container 31 can be performed either before or after loading the selected data items from the master data collection 11 into the data set 21 (112, 86). Preferably, association 84 is performed before loading the selected data 86.

By providing the data set 21 and associating the data set 21 with the view container 31, data virtualization and display can be realized since only the selected data items that are visible to a user in the view container 31 need to be rendered. In this way, performance of the application is improved because data items in the master data collection 11 that are not visible to the user are not loaded into the view container 31, thereby saving computing resources. A user therefore only operates on the data items that are viewable in the view container 31, as loaded in the data set 21, instead of on all the data items in the master data collection 11.

Where a user performs operations such as sorting or filtering (118), the master data collection 11 is configured to be accordingly updated (110). This in turn refreshes the data items loaded in the data set 21 (112) that correspond with the updated corresponding data items in the master data 11, so that the view container 31 displays up-to-date data items from the data set 21.

When functions such as scrolling and splitting a screen (119) are performed, no update of the master data collection 11 is required. Instead, the master data collection is merely read and the data set 21 is updated with the appropriate data items from the master data collection to reflect the scroll or split functions accordingly.

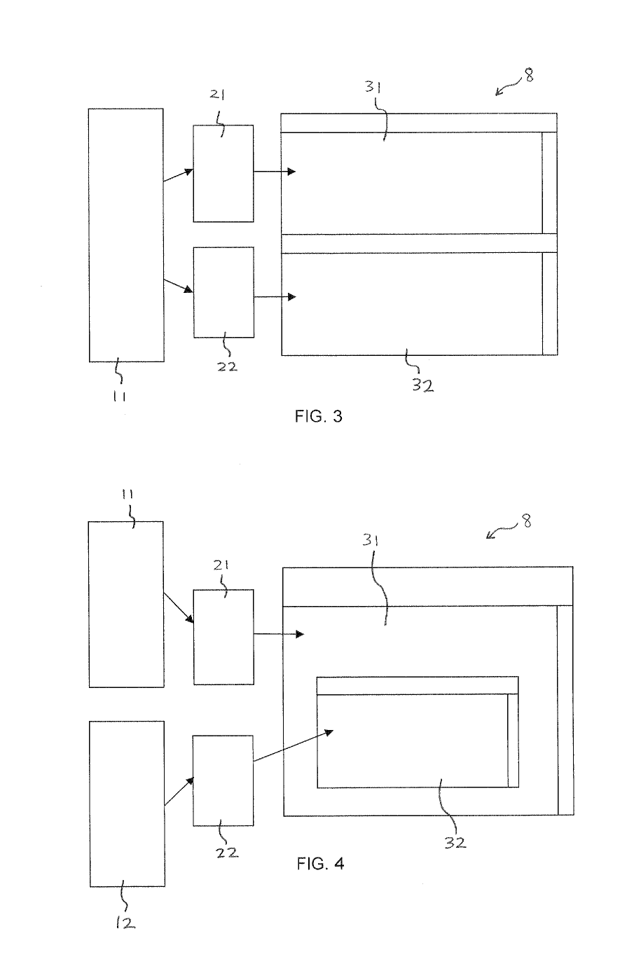

The method 80 and apparatus 8 are also configured to allow more than one view container to display data items. Each additional view container is always associated with a data set that is loaded with data items obtained from a master data collection. Various configurations of multiple view containers are described below with reference to the examples depicted in FIGS. 3 to 6.

For example, as depicted in FIG. 3, in the case of a user splitting a screen, a second view container 32 and a second data set 22 are provided, the second data set 22 being associated with the second view container 32. Further selected data items obtained from the master data collection 11 are loaded into the second data set 22 and accordingly automatically displayed in the second view container 32. The two view containers 31, 32 therefore display different collections of data items obtained from the same master data collection 11, thus providing the user with a split view of data items from the same master data collection 11. For example, where the master data collection 11 comprises many rows of data items, spaced apart rows may be separately displayed in the separate view containers 31, 32 arranged one on top of the other as depicted. Each data set 21, 22 is separately refreshed depending on the user separately performing operations on data items that are displayed in each view container 31, 32 respectively. For example, in a scroll operation, corresponding rows of data items in the data sets 21, 22 are updated according to the position of currently viewable data items in the view containers 31, 32. Upon removal of the split view, the data sets 21, 22 are synchronized accordingly so that only data items in data set 21 are displayed in view container 31, thereby resuming the configuration depicted in FIG. 1.

In the configuration depicted in FIG. 4, a second view container 32, a second data set 22 and a second master data collection 12 are provided. Predetermined data items obtained from the second master data collection 12 are loaded into the second data set 22. The predetermined data items are automatically displayed in the second view container 32 that is associated with the second data set 22. The second view container 32 may be displayed within the first view container 31 as depicted, as a hierarchy of views as may be used for grid-in-grid control.

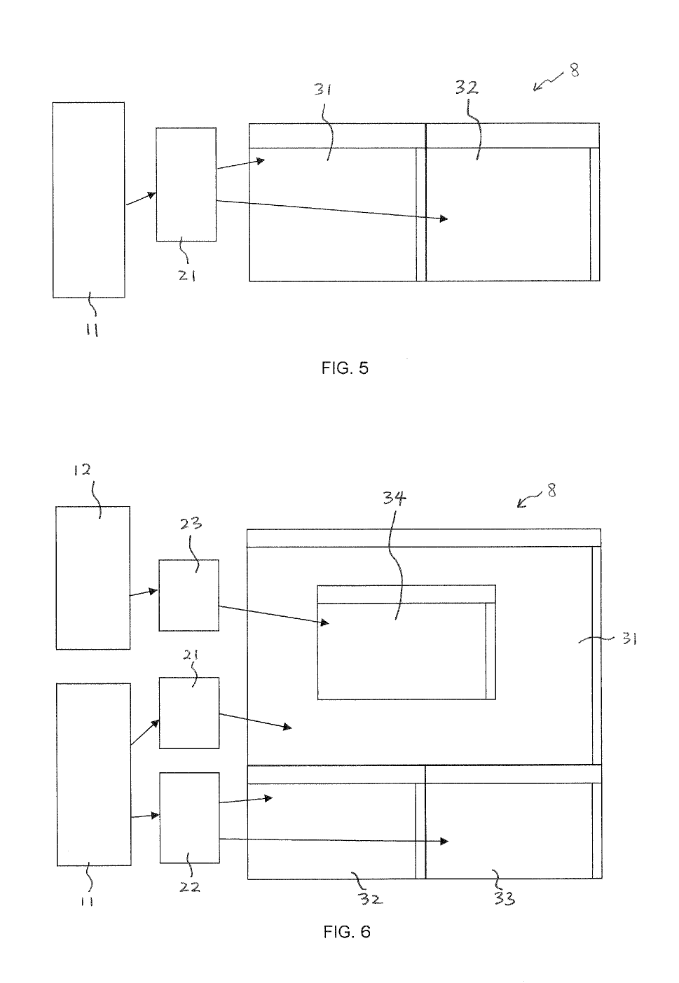

In the configuration depicted in FIG. 5, a second view container 32 is provided. The second view container 32 is associated with the data set 21, but displays data items that are another portion of the same selected data items obtained from the master data collection 11 and loaded in the data set 21. For example, where each data item comprises a single row having multiple columns, spaced apart columns may be separately displayed in the separate view containers 31, 32 arranged side by side as depicted, to indicate that they belong to a same row of data. In this way, multiple views of the same data items may be provided.

It is envisaged that various combinations and further levels of combinations of the different configurations depicted in FIGS. 3 to 5 may be implemented, where multiple view containers, multiple data sets and multiple master data collections may be provided as required or desired. An example of a combination of configurations is depicted in FIG. 6, wherein four view containers 31, 32, 33, 34 are provided for displaying data items from two master data collections 11, 12 that are loaded into three data sets 21, 22, 23. In this combination, three of the view containers 31, 32, 33 display data items from the first master data collection 11. The first view container 31 displays data loaded in the first data set 21 from the first master data collection 11. The first view container 31 is a split view with respect to the second and the third view containers 32, 33. The second and the third view containers 32, 33 display different portions of the same data items loaded in the second data set 22 from the first master data collection 11, thereby providing multiple views of the same data items. The fourth view container 34 is displayed within the first view container 31 as a hierarchy of views, and displays data items loaded in the third data set 23 from the second master data collection 12.

For an application product provided with the method 80 and apparatus 8 described in the various examples and embodiments above, initializing the application product preferably automatically displays in a view container a pre-selected set of data items that have been loaded into a data set from a master data collection. Pre-selection of the set of data items preferably is in accordance with a logical function comprising various factors which may include the properties of the view container and/or the size of the monitor used to display the view container.

Where data virtualization and display is implemented using user interface controls that do not natively support virtualization, custom sizing, positioning, scrolling of items and splitting of views may be performed manually as an overhead to implement. Similarly, for ‘sort’ or ‘filter’ functions, performing operations on one or more master data collections and subsequently updating the corresponding one or more data sets may also be another overhead to implement.

Whilst there has been described in the foregoing description preferred embodiments of the present invention, it will be understood by those skilled in the technology concerned that many variations or modifications in details of design or construction may be made without departing from the present invention.

1. A method of data virtualization and display, the method comprising:
providing a first data set;
providing a first view container for displaying data items therein and associating the first view container with the first data set;
loading the first data set with selected data items obtained from a first master data collection; and
automatically displaying the selected data items in the first view container.

2. The method of claim 1, further comprising updating corresponding data items in the first master data collection when specific data items displayed in the first view container are operated upon.

3. The method of claim 2, further comprising refreshing data items in the first data set that correspond with the updated corresponding data items in the first master data collection and automatically displaying the refreshed data items in the first view container.

4. The method of claim 1, further comprising providing a second view container for displaying data items therein.

5. The method of claim 4, further comprising associating the second view container with a second data set, loading the second data set with further selected data items obtained from the first master data collection; and automatically displaying the further selected data items in the second view container.

6. The method of claim 4, further comprising associating the second view container with a second data set, loading the second data set with predetermined data items obtained from a second master data collection; and automatically displaying the predetermined data items in the second view container.

7. The method of claim 6, further comprising displaying the second view container within the first view container.

8. The method of claim 4, further comprising associating the second view container with the first data set, and automatically displaying another portion of the selected data items loaded in the first data set in the second view container.

9. An apparatus for data virtualization and display, the apparatus comprising:
a first master data collection comprising a number of data items;
a first data set configured to be loaded with selected data items from the first master data collection; and
a first view container configured to display data items therein, the first view container being associated with the first data set such that the selected data items loaded in the first data set are automatically displayed by the first view container.

10. The apparatus of claim 9, wherein the first master data collection and the first view container are configured to update corresponding data items in the first master data collection when specific data items displayed in the first view container are operated upon.

11. The apparatus of claim 10, wherein the first master data collection and the first data set are configured to refresh data items in the first data set that correspond with the updated corresponding data items in the first master data collection such that the refreshed data items are automatically displayed in the first view container.

12. The apparatus of claim 9, further comprising a second view container configured to display data items therein.

13. The apparatus of claim 12, wherein the second view container is associated with a second data set, the second data set being configured to be loaded with further selected data items from the first master data collection, such that the further selected data items loaded in the second data set are automatically displayed by the second view container

14. The apparatus of claim 12, wherein the second view container is associated with a second data set, the second data set being configured to be loaded with predetermined data items from a second master data collection, such that the predetermined data items loaded in the second data set are automatically displayed by the second view container.

15. The apparatus of claim 14, wherein the second view container is configured to be displayed within the first view container.

16. The apparatus of claim 12, wherein the second view container is associated with the first data set, such that another portion of the selected data items loaded in the first data set are automatically displayed by the second view container.
